(19) United States
(12) Patent Application Publication
(10) Pub. No.: US 2004/0054526 A1
(43) Pub. Date: Mar. 18, 2004

(54) Phase alignment in speech processing

(75) Inventors: Dan Chazan, Haifa (IL); Zvi Kons, Nesher (IL)

Correspondence Address: IBM CORPORATION, INTELLECTUAL PROPERTY LAW DEPT., P.O. BOX 218, YORKTOWN HEIGHTS, NY, 10598, US

(73) Assignee: IBM

(21) Appl. No.: 10/243,580

(22) Filed: Sep. 13, 2002

(51) Int. Cl. G10L 11/04

(52) U.S. Cl. 704/206

(57) ABSTRACT

A speech encoder including a pitch detector operative to determine the pitch frequency of a speech segment, a spectral estimator operative to estimate the complex spectrum of the speech segment at the pitch frequency, an envelope encoder operative to calculate the amplitude of the complex spectrum, a phase aligner operative to remove a phase term which is linear in frequency from each of a plurality of complex values of the complex spectrum, and calculate a series of division products of each of the plurality of complex values by the square root of the absolute value of each of the complex values, where the series has a minimum total variation, thereby resulting in an aligned phase θₖ. and a phase encoder operative to encode the phase information.

### FIELD OF THE INVENTION

The present invention relates to speech processing in general, and more particularly to phase alignment thereof.

### BACKGROUND OF THE INVENTION

Many speech encoding and decoding systems represent voice segments by their spectral envelope. In some systems the segments are represented only by the absolute magnitude of the spectrum, and the phase is generated synthetically for the reconstruction. Such systems suffer from poor initial phase alignment which results in poor compression of phase data and poor combination with the synthetic phase. They also do not allow real and synthetic phase data to be combined in the same frame, and their final alignment suffers from poor segment connection.

### SUMMARY OF THE INVENTION

The present invention discloses a method for improving the sound quality of compressed speech by encoding the complex phase of the spectral envelope and using the encoded phase information during decoding to reproduce a speech segment having a smooth transition from the previous segment. The phase encoder of the present invention can work independently or in combination with amplitude encoding. During decoding, the decoder combines decoded phase information with the spectrum created from decoded amplitude information. The decoder then aligns the complex spectrum of the current segment with the spectrum of the previous segment to produce the desired pitch cycles. The present invention provides improved speech quality by using alignment both in the encoder and the decoder, by improving both alignment methods, and by allowing combination of real and synthetic phase data.

In one aspect of the present invention a speech encoder is provided including a pitch detector operative to determine the pitch frequency of a speech segment, a spectral estimator operative to estimate the complex spectrum of the speech segment at the pitch frequency, an envelope encoder operative to calculate the amplitude of the complex spectrum, a phase aligner operative to remove a phase term which is linear in frequency from each of a plurality of complex values of the complex spectrum, and calculate a series of division products of each of the plurality of complex values by the square root of the absolute value of each of the complex values, where the series has a minimum total variation, thereby resulting in an aligned phase θₖ, and a phase encoder operative to encode the phase information.

In another aspect of the present invention the spectral estimator is operative to estimate a signal of the complex spectrum at a time t as

$$x ( t ) ≅ {\sum }_{k} {A}_{k} {ⅇ}^{{ⅈϕ}_{k}} {ⅇ}^{2 π {if}_{k} t}$$

where Aₖ is the amplitude of the speech segment and φₖ is the phase of each pitch harmonic fₖ of the speech segment.

In another aspect of the present invention the spectral estimator is a Fourier transformator operative to calculate Fourier coefficients at multiples of the pitch frequency.

In another aspect of the present invention the phase aligner is operative to calculate the aligned phase θₖ of the complex spectrum after a time offset τ as θₖ=φₖ−2πτfₖ.

In another aspect of the present invention the phase aligner is operative to calculate the linear phase term having a coefficientτ being

$$τ = arg {min}_{τ} {\sum }_{k = 0}^{N - 1} {\vert \sqrt{{A}_{k + 1}} {ⅇ}^{{ⅈϕ}_{k + 1} - 2 πτ ( {f}_{k + 1} - {f}_{k} )} - \sqrt{{A}_{k}} {ⅇ}^{{ⅈϕ}_{k}} \vert}^{2}$$

where the coefficientτ is operative to minimize the total variation of the complex spectrum divided by the square root of its absolute value.

In another aspect of the present invention a phase aligner is provided including means for removing a phase term which is linear in frequency from each of a plurality of complex values of a complex spectrum of a speech segment, and means for calculating a series of division products of each of the plurality of complex values by the square root of the absolute value of each of the complex values, where the series has a minimum total variation, thereby resulting in an aligned phase θₖ.

In another aspect of the present invention the means for calculating is operative to calculate the aligned phase θₖ of the complex spectrum after a time offset τ as θₖ=φₖ−2πτfₖ.

In another aspect of the present invention the means for removing is operative to calculate the linear phase term having a coefficientτ being

$$τ = arg {min}_{τ} {\sum }_{k = 0}^{N - 1} {\vert \sqrt{{A}_{k + 1}} {ⅇ}^{{ⅈϕ}_{k + 1} - 2 πτ ( {f}_{k + 1} - {f}_{k} )} - \sqrt{{A}_{k}} {ⅇ}^{{ⅈϕ}_{k}} \vert}^{2}$$

where the coefficientτ is operative to minimize the total variation of the complex spectrum divided by the square root of its absolute value.

In another aspect of the present invention a speech decoder is provided including a spectrum reconstructor operative to reconstruct the spectrum of a speech segment from the amplitude envelope of the spectrum of the speech segment and pitch information, a phase combiner operative to reconstruct the complex spectrum of the speech segment from the reconstructed spectrum, phase information describing the speech segment, and pitch information describing the speech segment, a delay operative to store a complex spectrum of a previous speech segment, and a segment aligner operative to determine the relative offset between the complex spectrum of the speech segment and the complex spectrum of the previous speech segment, align the position of the first pitch excitation of the current speech segment to the last pitch excitation of the previous speech segment, and apply a time shift and a complex Hilbert filter to the complex spectra.

In another aspect of the present invention the speech decoder further includes an inverse Fourier transformator operative to convert the aligned complex spectra into time-domain signals and concatenate the time-domain signals with at least one other speech segment.

In another aspect of the present invention the pitch information describes the pitch of the speech segment prior to encoding.

In another aspect of the present invention the segment aligner is operative to cross-correlate the complex spectra as

$$C ( τ ) = {\sum }_{n = 0}^{N} {F}_{n} {\overline{G}}_{m} {ⅇ}^{- 2 π in τ} , m = ⌊ n \frac{{p}_{G}}{{p}_{F}} + 0.5 ⌋ .$$

where Fₙ and Gₘ are the computed complex magnitude of the pitch harmonics n and m of the current and previous spectra respectively, and p_{F} and p_{G} are their corresponding pitch periods.

In another aspect of the present invention the segment aligner is operative to cross-correlate on the Hilbert transform of the spectra and sum only the positive frequencies ( n, m≧0 ) of the spectra.

In another aspect of the present invention the segment aligner is operative to apply a time shift τₘ=arg max{|C(τ)|} and a constant phase shift θ₀=−arg(C(τₘ)) to the current spectrum.

In another aspect of the present invention the segment aligner is operative to determine the offset of the current complex spectrum as δ=nₚp_{G}−ΔT where there are

$${n}_{p} = ⌊ \frac{Δ T}{{p}_{G}} + 0.5 ⌋$$

pitch cycles in the previous complex spectrum, and where ΔT is the time offset between the complex spectra.

In another aspect of the present invention the segment aligner is operative to apply the time shift and the complex Hilbert filter by multiplying Fₙ(t) with e^{lΔθ}^{ₙ}, where Δθₙ is given by

$${Δθ}_{n} = \{ \begin{matrix}{θ}_{0} + n {θ}_{1} & n \geq 0 \\ - {θ}_{0} + n {θ}_{1} & n < 0\end{matrix} with {θ}_{1} = - 2 π ( {τ}_{m} + \frac{δ}{{p}_{F}} ) .$$

In another aspect of the present invention a segment aligner is provided including means for determining the relative offset between a complex spectrum of a speech segment and a complex spectrum of a previous speech segment, means for aligning the position of the first pitch excitation of the current speech segment to the last pitch excitation of the previous speech segment, and means for applying a time shift and a complex Hilbert filter to the complex spectra.

In another aspect of the present invention the means for determining is operative to cross-correlate the complex spectra as

$$\begin{matrix}C ( τ ) = {\sum }_{n = 0}^{N} {F}_{n} {\overline{G}}_{m} {ⅇ}^{- 2 π in τ} , \\ m = ⌊ n \frac{{p}_{G}}{{p}_{F}} + 0.5 ⌋ ,\end{matrix}$$

where Fₙ and Gₘ are the computed complex magnitude of the pitch harmonics n and m of the current and previous spectra respectively, and p_{F} and p_{G} are their corresponding pitch periods.

In another aspect of the present invention the means for determining is operative to cross-correlate on the Hilbert transform of the spectra and sum only the positive frequencies (n, m≧0) of the spectra.

In another aspect of the present invention the means for aligning is operative to apply a time shift τₘ=arg max{|C(τ)|} and a constant phase shift θ₀=−arg(C(τₘ)) to the current spectrum.

In another aspect of the present invention the means for determining is operative to determine the offset of the current complex spectrum as δ=nₚp_{G}−ΔT where there are

$${n}_{p} = ⌊ \frac{Δ T}{{p}_{G}} + 0.5 ⌋$$

pitch cycles in the previous complex spectrum, and where ΔT is the time offset between the complex spectra.

In another aspect of the present invention the means for aligning is operative to apply the time shift and the complex Hilbert filter by multiplying Fₙ(t) with e^{lΔθ}^{ₙ}, where Δθₙ is given by

$${Δθ}_{n} = \{ \begin{matrix}{θ}_{0} + n {θ}_{1} & n \geq 0 \\ - {θ}_{0} + n {θ}_{1} & n < 0\end{matrix} with {θ}_{1} = - 2 π ( {τ}_{m} + \frac{δ}{{p}_{F}} ) .$$

In another aspect of the present invention a method is provided for speech encoding including determining the pitch frequency of a speech segment, estimating the complex spectrum of the speech segment at the pitch frequency, calculating the amplitude of the complex spectrum, removing a phase term which is linear in frequency from each of a plurality of complex values of the complex spectrum, calculating a series of division products of each of the plurality of complex values by the square root of the absolute value of each of the complex values, where the series has a minimum total variation, thereby resulting in an aligned phase θₖ, and encoding the phase information.

In another aspect of the present invention the estimating step includes estimating a signal of the complex spectrum at a time t as

$$x ( t ) ≅ {\sum }_{k} {A}_{k} {ⅇ}^{{ⅈϕ}_{k}} {ⅇ}^{2 π {if}_{k} t}$$

where Aₖ is the amplitude of the speech segment and φₖ is the phase of each pitch harmonic fₖ of the speech segment.

In another aspect of the present invention the estimating step includes calculating Fourier coefficients at multiples of the pitch frequency.

In another aspect of the present invention the calculating a series step includes calculating the aligned phase θₖ of the complex spectrum after a time offset τ as θₖ=φₖ−2πτfₖ.

In another aspect of the present invention the removing step includes calculating the linear phase term having a coefficientτ being

$$τ = arg {min}_{τ} {\sum \vert}_{k = 0}^{N - 1} \sqrt{{A}_{k + 1}} {ⅇ}^{ⅈ {ϕ}_{k + 1} - 2 π τ ( {f}_{k + 1} - {f}_{k} )} - \sqrt{{A}_{k}} {ⅇ}^{ⅈ {ϕ}_{k}} {\vert}^{2}$$

where the coefficientτ is operative to minimize the total variation of the complex spectrum divided by the square root of its absolute value.

In another aspect of the present invention a method is provided for phase aligning including removing a phase term which is linear in frequency from each of a plurality of complex values of a complex spectrum of a speech segment, and calculating a series of division products of each of the plurality of complex values by the square root of the absolute value of each of the complex values, where the series has a minimum total variation, thereby resulting in an aligned phase θₖ.

In another aspect of the present invention the calculating step includes calculating the aligned phase θₖ of the complex spectrum after a time offset τ as θₖ=φₖ−2πτfₖ.

In another aspect of the present invention the removing step includes calculating the linear phase term having a coefficientτ being

$$τ = arg {min}_{τ} {\sum \vert}_{k = 0}^{N - 1} \sqrt{{A}_{k + 1}} {ⅇ}^{ⅈ {ϕ}_{k + 1} - 2 π τ ( {f}_{k + 1} - {f}_{k} )} - \sqrt{{A}_{k}} {ⅇ}^{ⅈ {ϕ}_{k}} {\vert}^{2}$$

where the coefficientτ is operative to minimize the total variation of the complex spectrum divided by the square root of its absolute value.

In another aspect of the present invention a method is provided for speech decoding including reconstructing the spectrum of a speech segment from the amplitude envelope of the spectrum of the speech segment and pitch information, reconstructing the complex spectrum of the speech segment from the reconstructed spectrum, phase information describing the speech segment, and pitch information describing the speech segment, storing a complex spectrum of a previous speech segment, determining the relative offset between the complex spectrum of the speech segment and the complex spectrum of the previous speech segment, aligning the position of the first pitch excitation of the current speech segment to the last pitch excitation of the previous speech segment, and applying a time shift and a complex Hilbert filter to the complex spectra.

In another aspect of the present invention the method further includes converting the aligned complex spectra into time-domain signals, and concatenating the time-domain signals with at least one other speech segment.

In another aspect of the present invention the reconstructing the spectrum step includes reconstructing with the pitch information that describes the pitch of the speech segment prior to encoding.

In another aspect of the present invention the determining step includes cross-correlating the complex spectra as

$$C ( τ ) = {\sum }_{n = 0}^{N} {F}_{n} {\overline{G}}_{m} {ⅇ}^{- 2 πⅈ n τ} , m = ⌊ n \frac{{p}_{G}}{{p}_{F}} + 0.5 ⌋ .$$

where Fₙ and Gₘ are the computed complex magnitude of the pitch harmonics n and m of the current and previous spectra respectively, and p_{F} and p_{G} are their corresponding pitch periods.

In another aspect of the present invention the determining step includes cross-correlating on the Hilbert transform of the spectra and sum only the positive frequencies (n, m≧0) of the spectra.

In another aspect of the present invention the aligning step includes applying a time shift τₘ=arg max{|C(τ)|} and a constant phase shift θ₀=−arg(C(τₘ)) to the current spectrum.

In another aspect of the present invention the determining step includes determining the offset of the current complex spectrum as δ=nₚp_{G}−ΔT where there are

$${n}_{p} = ⌊ \frac{Δ T}{{p}_{G}} + 0.5 ⌋$$

pitch cycles in the previous complex spectrum, and where ΔT is the time offset between the complex spectra.

In another aspect of the present invention the aligning step includes applying the time shift and the complex Hilbert filter by multiplying Fₙ(t) with e^{lΔθ}^{ₙ}, where Δθₙ is given by

$$Δ {θ}_{n} = \{ \begin{matrix}{θ}_{0} + n {θ}_{1} n \geq 0 \\ - {θ}_{0} + n {θ}_{1} n < 0 \end{matrix} with {θ}_{1} = - 2 π ( {τ}_{m} + \frac{δ}{{p}_{F}} ) .$$

In another aspect of the present invention a method is provided for segment aligning including determining the relative offset between a complex spectrum of a speech segment and a complex spectrum of a previous speech segment, aligning the position of the first pitch excitation of the current speech segment to the last pitch excitation of the previous speech segment, and applying a time shift and a complex Hilbert filter to the complex spectra.

In another aspect of the present invention the determining step includes cross-correlating the complex spectra as

$$C ( τ ) = {\sum }_{n = 0}^{N} {F}_{n} {\overline{G}}_{m} {ⅇ}^{- 2 π ⅈ n τ} , m = ⌊ n \frac{{p}_{G}}{{p}_{F}} + 0.5 ⌋ ,$$

where Fₙ and Gₘ are the computed complex magnitude of the pitch harmonics n and m of the current and previous spectra respectively, and p_{F} and p_{G} are their corresponding pitch periods.

In another aspect of the present invention the determining step includes cross-correlating on the Hilbert transform of the spectra and sum only the positive frequencies (n, m≧0) of the spectra.

In another aspect of the present invention the aligning step includes applying a time shift τₘ=arg max{|C(τ)|} and a constant phase shift θ₀=−arg(C(τₘ)) to the current spectrum.

In another aspect of the present invention the determining step includes determining the offset of the current complex spectrum as δ=nₚp_{G}−ΔT where there are

$${n}_{p} = ⌊ \frac{Δ T}{{p}_{G}} + 0.5 ⌋$$

pitch cycles in the previous complex spectrum, and where ΔT is the time offset between the complex spectra.

In another aspect of the present invention the aligning step includes applying the time shift and the complex Hilbert filter by multiplying Fₙ(t) with e^{lΔθ}^{ₙ}, where Δθₙ is given by

$$Δ {θ}_{n} = \{ \begin{matrix}{θ}_{0} + n {θ}_{1} n \geq 0 \\ - {θ}_{0} + n {θ}_{1} n < 0 \end{matrix} with {θ}_{1} = - 2 π ( {τ}_{m} + \frac{δ}{{p}_{F}} ) .$$

In another aspect of the present invention a computer program is provided embodied on a computer-readable medium, the computer program including a first code segment operative to determine the pitch frequency of a speech segment, a second code segment operative to estimate the complex spectrum of the speech segment at the pitch frequency, a third code segment operative to calculate the amplitude of the complex spectrum, a fourth code segment operative to remove a phase term which is linear in frequency from each of a plurality of complex values of the complex spectrum, and calculate a series of division products of each of the plurality of complex values by the square root of the absolute value of each of the complex values, where the series has a minimum total variation, thereby resulting in an aligned phase θₖ, and a fifth code segment operative to encode the phase information.

In another aspect of the present invention a computer program is provided embodied on a computer-readable medium, the computer program including a first code segment operative to reconstruct the spectrum of a speech segment from the amplitude envelope of the spectrum of the speech segment and pitch information, a second code segment operative to reconstruct the complex spectrum of the speech segment from the reconstructed spectrum, phase information describing the speech segment, and pitch information describing the speech segment, a third code segment operative to store a complex spectrum of a previous speech segment, and a fourth code segment operative to determine the relative offset between the complex spectrum of the speech segment and the complex spectrum of the previous speech segment, align the position of the first pitch excitation of the current speech segment to the last pitch excitation of the previous speech segment, and apply a time shift and a complex Hilbert filter to the complex spectra.

### BRIEF DESCRIPTION OF THE DRAWINGS

The present invention will be understood and appreciated more fully from the following detailed description taken in conjunction with the appended drawings in which:

FIG. 1 is a simplified block diagram illustration of a speech encoder, constructed and operative in accordance with a preferred embodiment of the present invention;

FIG. 2 is a simplified flow illustration of an exemplary method of operation of phase aligner 106 of the speech encoder of FIG. 1, operative in accordance with a preferred embodiment of the present invention;

FIG. 3 is a simplified block diagram illustration of a speech decoder, constructed and operative in accordance with a preferred embodiment of the present invention;

FIG. 4 is a simplified flow illustration of an exemplary method of operation of phase combiner 302 of the speech decoder of FIG. 3, operative in accordance with a preferred embodiment of the present invention;

FIG. 5 is a simplified flow illustration of an exemplary method of operation of segment aligner 304 of the speech decoder of FIG. 3, operative in accordance with a preferred embodiment of the present invention; and

FIGS. 6A, 6B, and 6C are simplified graphical illustrations showing the phase alignment of speech segments in accordance with the application of the methods of the present invention.

### DETAILED DESCRIPTION OF PREFERRED EMBODIMENTS

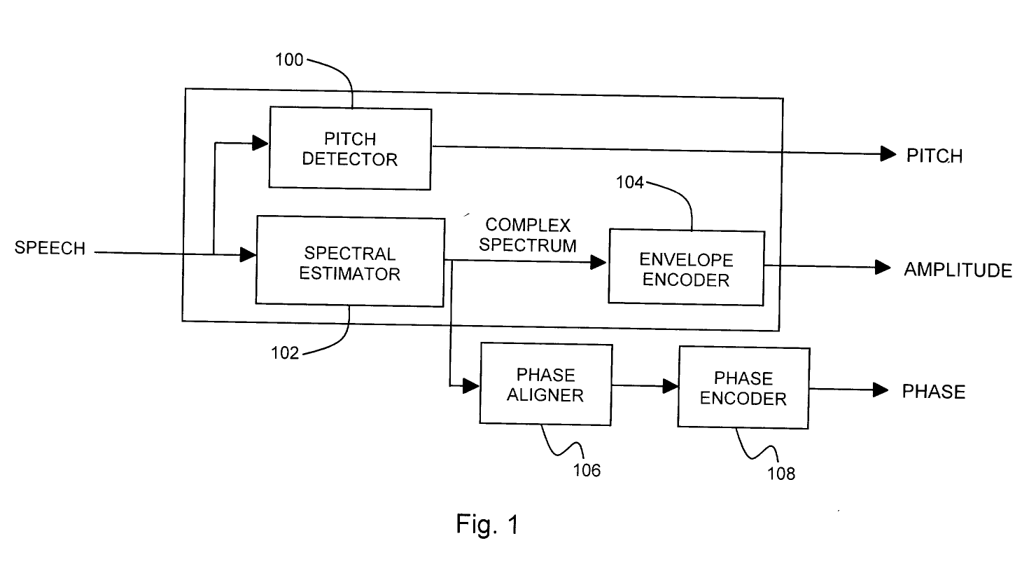

Reference is now made to FIG. 1, which is a simplified block diagram illustration of a speech encoder, constructed and operative in accordance with a preferred embodiment of the present invention. In the speech encoder of FIG. 1, a speech segment is input into a pitch detector 100 which determines the pitch of the speech segment. The speech segment is also input into a spectral estimator 102, such as a Fourier transformator, which estimates the complex spectrum of the speech segment. An envelope encoder 104 calculates the amplitude of the complex spectrum. A phase aligner 106 extracts the phase information from the complex spectrum. The phase information is then encoded at a phase encoder 108.

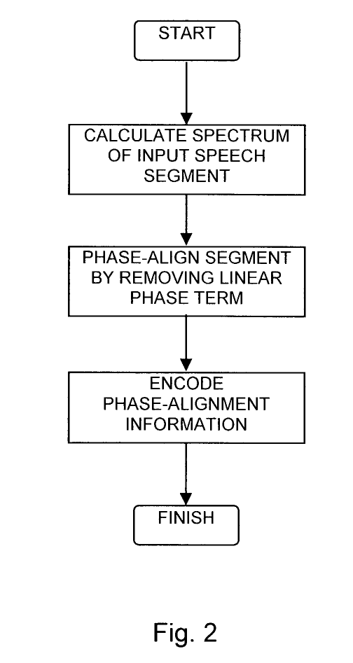

Reference is now made to FIG. 2, which is a simplified flow illustration of an exemplary method of operation of phase aligner 106 of the speech encoder of FIG. 1, operative in accordance with a preferred embodiment of the present invention. In the method of FIG. 2 the spectrum of the input speech segment is calculated. For a voiced segment, the speech signal at time t is estimated by the amplitudes Aₖ and the phases φₖ of each pitch harmonics fₖ

$$x ( t ) ≅ {\sum }_{k}^{} {A}_{k} {ⅇ}^{ⅈ {ϕ}_{k}} {ⅇ}^{2 π ⅈ {f}_{k} t}$$

The segment is then phase-aligned by removing a linear phase term in order to smooth the phase data and reduce phase wrapping. The aligned phase θₖ after a time offset τ is applied will be:

θₖ=φₖ−2πτfₖ

τ is preferably selected to make the complex spectrum as smooth as possible by minimizing the total variation of the of the spectrum divided by the square root of it's absolute value:

$$τ = arg {min}_{τ} {\sum \vert}_{k = 0}^{N - 1} \sqrt{{A}_{k + 1}} {ⅇ}^{ⅈ {ϕ}_{k + 1} - 2 π τ ( {f}_{k + 1} - {f}_{k} )} - \sqrt{{A}_{k}} {ⅇ}^{ⅈ {ϕ}_{k}} {\vert}^{2} .$$

Since the aligned phase is smooth it is possible to estimate the complex spectrum at an arbitrary frequency by interpolation and to combine it with a phase produced by any conventional method.

In order to reduce the amount of data to be encoded, it is possible to encode only the phase of the first M pitch harmonics, where M is a parameter that controls the trade-off between quality and bandwidth. It may be user-defined or set automatically using preset values according to various parameters such as the speech bandwidth, the speaker voice, and the required quality.

The aligned phase θₙ is then encoded using quantization and/or compression by any suitable methods known in the art.

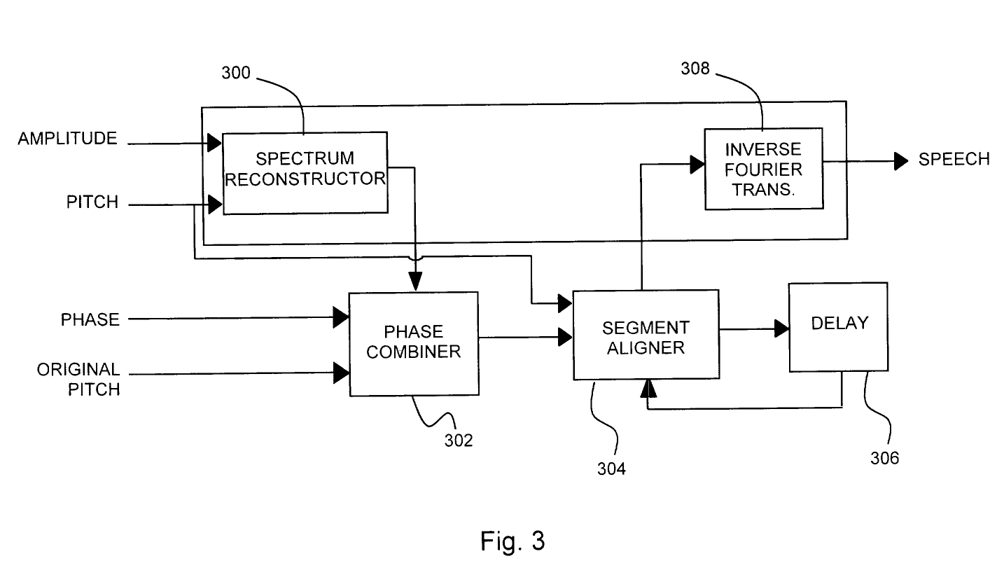

Reference is now made to FIG. 3, which is a simplified block diagram illustration of a speech decoder, constructed and operative in accordance with a preferred embodiment of the present invention. In the speech decoder of FIG. 3, the spectrum of a speech segment is reconstructed at a spectrum reconstructor 300 using conventional means by inputting the amplitude envelope of the spectrum of the speech segment together with pitch information, which may be user-defined using known techniques, and which may or may not match the pitch of the original speech segment. The reconstructed spectrum is then input into a phase combiner 302 together with the encoded phase information and the pitch information of the original speech segment. Phase combiner 302 decodes the encoded information and reconstructs the segment's complex spectrum. The complex spectrum and the user-defined pitch information is then input into a segment aligner 304 which pitch-aligns the complex phase of the spectrum of the current speech segment to a previous speech segment that is stored in a delay 306. The phase-aligned spectrum is then input into an inverse Fourier transformator 308 which converts it into time-domain signals and concatenates it with the previous speech segment.

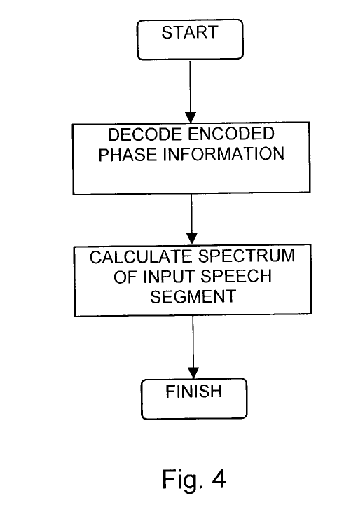

Reference is now made to FIG. 4, which is a simplified flow illustration of exemplary method of operation of phase combiner 302 of the speech decoder of FIG. 3, operative in accordance with a preferred embodiment of the present invention. In the method of FIG. 4 the encoded phase is decoded and the values of the input speech segment's spectrum are set by:

$${F}_{n} = \{ \begin{matrix}{A}_{n}^{′} {ⅇ}^{ⅈ {θ}_{n}} & n < M \\ {A}_{n}^{′} {ⅇ}^{ⅈ {φ}_{n}} & otherwise\end{matrix}$$

where A′ₙe^{lφ}^{ₙ} is the spectrum reconstructed from the encoded amplitude and pitch only, using a synthetic phase. When the pitch of the original segment differs from the pitch of the reconstructed segment, linear interpolation of the decoded phase may be used in order to estimate the phase values at the required frequencies.

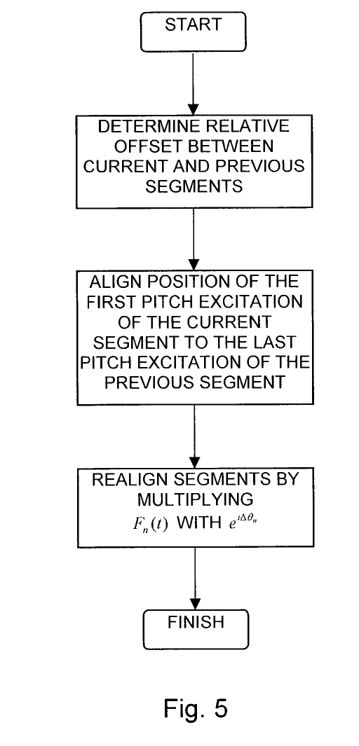

Reference is now made to FIG. 5, which is a simplified flow illustration of an exemplary method of operation of segment aligner 304 of the speech decoder of FIG. 3, operative in accordance with a preferred embodiment of the present invention. In the method of FIG. 5, the relative offset between the current segment and the previous one is determined. The relative alignment between the segments may be found from their cross correlation function:

$$C ( τ ) = {\sum }_{n = 0}^{N} {F}_{n} {\overline{G}}_{m} {ⅇ}^{- 2 π ⅈ n τ} , m = ⌊ n \frac{{p}_{G}}{{p}_{F}} + 0.5 ⌋ .$$

where Fₙ and Gₘ are the computed complex magnitude of the pitch harmonics n and m of the current and previous segments respectively, and p_{F} and p_{G} are the corresponding pitch periods. The correlation is preferably performed on the Hilbert transform of the segments, and thus only the positive frequencies (n, m≧0) are summed. Optimal correlation of the two Hilbert-transformed signals is preferably achieved by applying a time shift:

τₘ=arg max{|C(τ)|}

and a complex phase shift θ₀=−arg(C(τₘ)) to the current segment.

After the two segments are relatively aligned, the position of the first pitch excitation of the current segment is aligned to the last pitch excitation of the previous segment. If in the previous segment there are

$${n}_{p} = ⌊ \frac{Δ T}{{p}_{G}} + 0.5 ⌋$$

pitch cycles, where ΔT is the time offset between segments, the offset in the current segment will be

δ=nₚp_{G}−ΔT.

The segments are then realigned by applying a time shift and a complex Hilbert filter. This is achieved by multiplying Fₙ(t) with e^{lΔθ}^{ₙ}, where Δθₙ is given by

$$Δ {θ}_{n} = \{ \begin{matrix}{θ}_{0} + n {θ}_{1} & n \geq 0 \\ - {θ}_{0} + n {θ}_{1} & n < 0\end{matrix} \\ with \\ {θ}_{1} = - 2 π ( {τ}_{m} + \frac{δ}{{p}_{I}} )$$

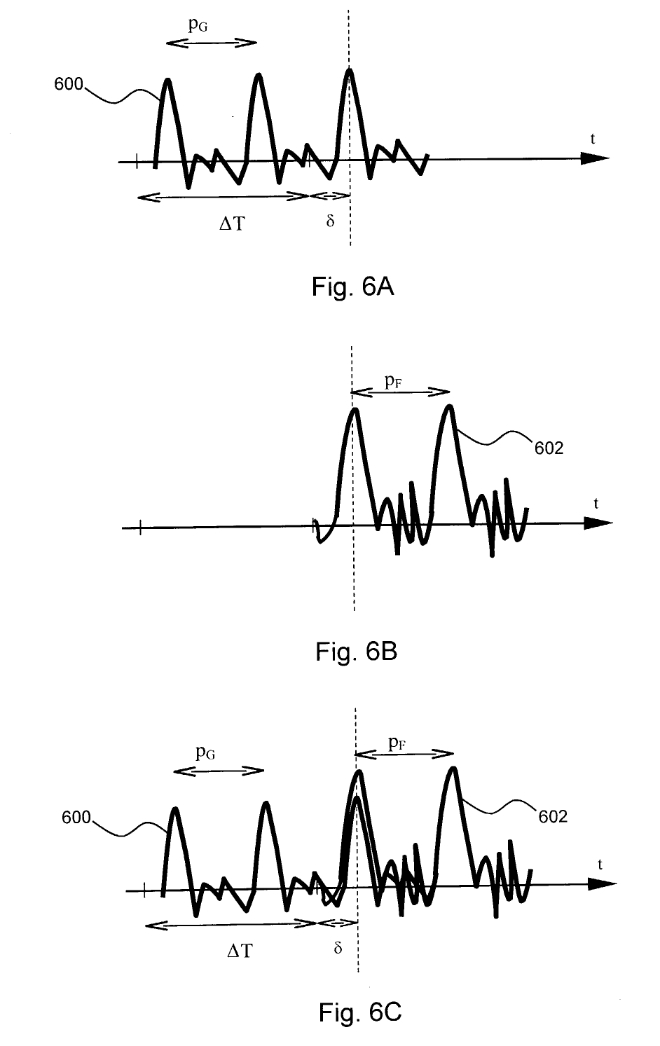

FIGS. 6A, 6B, and 6C are simplified graphical illustrations showing the phase alignment of two speech segments 600 and 602 in accordance with the application of the methods of the present invention described hereinabove.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A speech encoder comprising:
a pitch detector operative to determine the pitch frequency of a speech segment;
a spectral estimator operative to estimate the complex spectrum of said speech segment at said pitch frequency;
an envelope encoder operative to calculate the amplitude of said complex spectrum;
a phase aligner operative to:
remove a phase term which is linear in frequency from each of a plurality of complex values of the complex spectrum; and
calculate a series of division products of each of the plurality of complex values by the square root of the absolute value of each of said complex values, wherein said series has a minimum total variation, thereby resulting in an aligned phase θₖ; and
a phase encoder operative to encode said phase information.

2. A speech encoder according to claim 1 wherein said spectral estimator is operative to estimate a signal of said complex spectrum at a time t as
$$x ( t ) ≅ {\sum }_{k}^{} {A}_{k} {ⅇ}^{ⅈ {ϕ}_{k}} {ⅇ}^{2 π ⅈ {f}_{k} t}$$
where Aₖ is the amplitude of said speech segment and φₖ is the phase of each pitch harmonic fₖ of said speech segment.

3. A speech encoder according to claim 2 wherein said spectral estimator is a Fourier transformator operative to calculate Fourier coefficients at multiples of said pitch frequency.

4. A speech encoder according to claim 1 wherein said phase aligner is operative to calculate said aligned phase θₖ of said complex spectrum after a time offset τ as θₖ=φₖ−2πτfₖ.

5. A speech encoder according to claim 1 wherein said phase aligner is operative to calculate said linear phase term having a coefficientτ being
$$τ = {argmin}_{τ} {\sum }_{k = 0}^{N - 1} {\vert \sqrt{{A}_{k + 1}} {ⅇ}^{ⅈ {ϕ}_{k + 1} - 2 π τ ( {f}_{k + 1} - {f}_{k} )} - \sqrt{{A}_{k}} {ⅇ}^{ι {ϕ}_{k}} \vert}^{2}$$
wherein said coefficientτ is operative to minimize the total variation of said complex spectrum divided by the square root of its absolute value.

6. A phase aligner comprising:
means for removing a phase term which is linear in frequency from each of a plurality of complex values of a complex spectrum of a speech segment; and
means for calculating a series of division products of each of the plurality of complex values by the square root of the absolute value of each of said complex values, wherein said series has a minimum total variation, thereby resulting in an aligned phase θₖ.

7. A phase aligner according to claim 6 wherein said means for calculating is operative to calculate said aligned phase θₖ of said complex spectrum after a time offset τ as θₖ=φₖ−2πτfₖ.

8. A phase aligner according to claim 6 wherein said means for removing is operative to calculate said linear phase term having a coefficientτ being
$$τ = {argmin}_{τ} {\sum }_{k = 0}^{N - 1} {\vert \sqrt{{A}_{k + 1}} {ⅇ}^{ⅈ {ϕ}_{k + 1} - 2 π τ ( {f}_{k + 1} - {f}_{k} )} - \sqrt{{A}_{k}} {ⅇ}^{ι {ϕ}_{k}} \vert}^{2}$$
wherein said coefficient: is operative to minimize the total variation of said complex spectrum divided by the square root of its absolute value.

9. A speech decoder comprising:
a spectrum reconstructor operative to reconstruct the spectrum of a speech segment from the amplitude envelope of the spectrum of said speech segment and pitch information;
a phase combiner operative to reconstruct the complex spectrum of said speech segment from said reconstructed spectrum, phase information describing said speech segment, and pitch information describing said speech segment;
a delay operative to store a complex spectrum of a previous speech segment; and
a segment aligner operative to:
determine the relative offset between said complex spectrum of said speech segment and the complex spectrum of said previous speech segment;
align the position of the first pitch excitation of said current speech segment to the last pitch excitation of said previous speech segment; and
apply a time shift and a complex Hilbert filter to said complex spectra.

10. A speech decoder according to claim 9 and further comprising an inverse Fourier transformator operative to convert said aligned complex spectra into time-domain signals and concatenate said time-domain signals with at least one other speech segment.

11. A speech decoder according to claim 9 wherein said pitch information describes the pitch of said speech segment prior to encoding.

12. A speech decoder according to claim 9 wherein said segment aligner is operative to cross-correlate said complex spectra as
$$C ( τ ) = {\sum }_{n = 0}^{N} {F}_{n} {\overline{G}}_{m} {ⅇ}^{- 2 π ⅈ n τ} , m = ⌊ n \frac{{p}_{G}}{{p}_{F}} + 0.5 ⌋ .$$
where Fₙ and Gₘ are the computed complex magnitude of the pitch harmonics n and m of the current and previous spectra respectively, and p_{F} and p_{G} are their corresponding pitch periods.

13. A speech decoder according to claim 12 wherein said segment aligner is operative to cross-correlate on the Hilbert transform of said spectra and sum only the positive frequencies (n, m≧0) of said spectra.

14. A speech decoder according to claim 12 wherein said segment aligner is operative to apply a time shiftτₘ=arg max{|C(τ)|} and a constant phase shift θ₀=−arg(C(τₘ)) to said current spectrum.

15. A speech decoder according to claim 9 wherein said segment aligner is operative to determine said offset of said current complex spectrum as δ=nₚp_{G}−ΔT where there are
$${n}_{p} = ⌊ \frac{Δ T}{{p}_{G}} + 0.5 ⌋$$
pitch cycles in said previous complex spectrum, and where ΔT is the time offset between said complex spectra.

16. A speech decoder according to claim 9 wherein said segment aligner is operative to apply said time shift and said complex Hilbert filter by multiplying Fₙ(t) with e^{lΔθ}^{ₙ}, where Δθₙ is given by
$$Δ {θ}_{n} = \{ \begin{matrix}{θ}_{0} + n {θ}_{1} & n \geq 0 \\ - {θ}_{0} + n {θ}_{1} & n < 0\end{matrix} \\ with \\ {θ}_{1} = - 2 π ( {τ}_{m} + \frac{δ}{{p}_{F}} ) .$$

17. A segment aligner comprising:
means for determining the relative offset between a complex spectrum of a speech segment and a complex spectrum of a previous speech segment;
means for aligning the position of the first pitch excitation of said current speech segment to the last pitch excitation of said previous speech segment; and
means for applying a time shift and a complex Hilbert filter to said complex spectra.

18. A segment aligner according to claim 17 wherein said means for determining is operative to cross-correlate said complex spectra as
$$C ( τ ) = {\sum }_{n = 0}^{N} {F}_{n} {\overline{G}}_{m} {ⅇ}^{- 2 π ⅈ n τ} , m = ⌊ n \frac{{p}_{G}}{{p}_{F}} + 0.5 ⌋ ,$$
where Fₙ and Gₘ are the computed complex magnitude of the pitch harmonics n and m of the current and previous spectra respectively, and p_{F} and p_{G} are their corresponding pitch periods.

19. A segment aligner according to claim 18 wherein said means for determining is operative to cross-correlate on the Hilbert transform of said spectra and sum only the positive frequencies (n, m≧0) of said spectra.

20. A segment aligner according to claim 18 wherein said means for aligning is operative to apply a time shiftτₘ=arg max{|C(τ)|} and a constant phase shift θ₀=−arg(C(τₘ)) to said current spectrum.

21. A segment aligner according to claim 17 wherein said means for determining is operative to determine said offset of said current complex spectrum as δ=nₚp_{G}−ΔT where there are
$${n}_{p} = ⌊ \frac{Δ T}{{p}_{G}} + 0.5 ⌋$$
pitch cycles in said previous complex spectrum, and where ΔT is the time offset between said complex spectra.

22. A segment aligner according to claim 17 wherein said means for aligning is operative to apply said time shift and said complex Hilbert filter by multiplying Fₙ(t) with e^{lΔθ}^{ₙ}, whereΔθₙ is given by
$$\begin{matrix}Δ {θ}_{n} = \{ \begin{matrix}{θ}_{0} + n {θ}_{1} & n \geq 0 \\ - {θ}_{0} + n {θ}_{1} & n < 0\end{matrix} \\ with \\ {θ}_{1} = - 2 π ( {τ}_{m} + \frac{δ}{{p}_{F}} ) .\end{matrix}$$

23. A method for speech encoding comprising:
determining the pitch frequency of a speech segment;
estimating the complex spectrum of said speech segment at said pitch frequency;
calculating the amplitude of said complex spectrum;
removing a phase term which is linear in frequency from each of a plurality of complex values of the complex spectrum;
calculating a series of division products of each of the plurality of complex values by the square root of the absolute value of each of said complex values, wherein said series has a minimum total variation, thereby resulting in an aligned phase θₖ; and
encoding said phase information.

24. A method according to claim 23 wherein said estimating step comprises estimating a signal of said complex spectrum at a time t as
$$x ( t ) ≅ {\sum }_{k}^{} {A}_{k} {ⅇ}^{ⅈ {ϕ}_{k}} {ⅇ}^{2 π ⅈ {f}_{k} t}$$
where Aₖ is the amplitude of said speech segment and φₖ is the phase of each pitch harmonic fₖ of said speech segment.

25. A method according to claim 23 wherein said calculating a series step comprises calculating said aligned phase θₖ of said complex spectrum after a time offset τ as θₖ=φₖ−2πτfₖ.

26. A method according to claim 23 wherein said removing step comprises calculating said linear phase term having a coefficientτ being
$$τ = arg {min}_{τ} {\sum }_{k = 0}^{N - 1} {\vert \sqrt{{A}_{k + 1}} {ⅇ}^{ⅈ {ϕ}_{k + 1} - 2 π τ ( {f}_{k + 1} - {f}_{k} )} - \sqrt{{A}_{k}} {ⅇ}^{ⅈ {ϕ}_{k}} \vert}^{2}$$
wherein said coefficients is operative to minimize the total variation of said complex spectrum divided by the square root of its absolute value.

27. A method for speech decoding comprising:
reconstructing the spectrum of a speech segment from the amplitude envelope of the spectrum of said speech segment and pitch information;
reconstructing the complex spectrum of said speech segment from said reconstructed spectrum, phase information describing said speech segment, and pitch information describing said speech segment;
storing a complex spectrum of a previous speech segment;
determining the relative offset between said complex spectrum of said speech segment and the complex spectrum of said previous speech segment;
aligning the position of the first pitch excitation of said current speech segment to the last pitch excitation of said previous speech segment; and
applying a time shift and a complex Hilbert filter to said complex spectra.

28. A method according to claim 27 and further comprising:
converting said aligned complex spectra into time-domain signals; and
concatenating said time-domain signals with at least one other speech segment.

29. A method for segment aligning comprising:
determining the relative offset between a complex spectrum of a speech segment and a complex spectrum of a previous speech segment;
aligning the position of the first pitch excitation of said current speech segment to the last pitch excitation of said previous speech segment; and
applying a time shift and a complex Hilbert filter to said complex spectra.

30. A computer program embodied on a computer-readable medium, the computer program comprising:
a first code segment operative to determine the pitch frequency of a speech segment;
a second code segment operative to estimate the complex spectrum of said speech segment at said pitch frequency;
a third code segment operative to calculate the amplitude of said complex spectrum;
a fourth code segment operative to:
remove a phase term which is linear in frequency from each of a plurality of complex values of the complex spectrum; and
calculate a series of division products of each of the plurality of complex values by the square root of the absolute value of each of said complex values, wherein said series has a minimum total variation, thereby resulting in an aligned phase θₖ; and
a fifth code segment operative to encode said phase information.

31. A computer program embodied on a computer-readable medium, the computer program comprising:
a first code segment operative to reconstruct the spectrum of a speech segment from the amplitude envelope of the spectrum of said speech segment and pitch information;
a second code segment operative to reconstruct the complex spectrum of said speech segment from said reconstructed spectrum, phase information describing said speech segment, and pitch information describing said speech segment;
a third code segment operative to store a complex spectrum of a previous speech segment; and
a fourth code segment operative to:
determine the relative offset between said complex spectrum of said speech segment and the complex spectrum of said previous speech segment;
align the position of the first pitch excitation of said current speech segment to the last pitch excitation of said previous speech segment; and
apply a time shift and a complex Hilbert filter to said complex spectra.
